(19) United States
(12) Patent Application Publication
(10) Pub. No.: US 2015/0168064 A1
(43) Pub. Date: Jun. 18, 2015

(54) LAUNDRY DRYER WITH EMERGENCY CLOSING VENTILATION SYSTEM

(71) Applicant: Electrolux Appliances Aktiebolag, Stockholm (SE)

(72) Inventors: Luigi Ingrosso, Travesio (IT); Federico Sussarello, M. Argentario (IT); Piercarlo Novelli, San Quirino (IT); Rudy Bisaro, Valvasone (IT)

(73) Assignee: Electrolux Appliances Aktiebolag, Stockholm (SE)

(21) Appl. No.: 14/109,216

(22) Filed: Dec. 17, 2013

(51) Int. Cl. F26B 21/12

(52) U.S. Cl. CPC F26B 21/12

(57) ABSTRACT

A tumble dryer is provided with an air closure system. The air closure system may suppress and/or conceal a fire or burning within a tumble dryer. The air closure system may include an air closure assembly including a guide mountable to a portion of the tumble dryer's ventilation system, and a shutter movably coupled to the guide. The air closure system may further include a sensor configured to complete a circuit supplying electricity to an actuator provided at the air closure assembly when the sensor senses a condition indicative of a fire or burning within the tumble dryer. In response, the actuator may release the shutter such that it closes off an opening within the guide and restricts the airflow through the ventilation system, thus suppressing and concealing the fire or burning within the tumble dryer.

### TECHNICAL FIELD

The present invention relates generally to laundry dryers. In particular, the invention relates to a laundry dryer that employs an emergency closing ventilation system.

### BACKGROUND

During operation, a conventional tumble dryer, via a ventilation system provided therein, draws air from the surrounding area, directs air into the drying chamber or drum of the dryer, and exhausts air and retained water vapor through a channel to the outside. As used herein, a dryer's “ventilation system” refers to the various ducts, channels, fans, blowers, manifolds, etc., used to move air and direct airflow throughout the dryer, from an air intake ultimately to an air exhaust. As shown in FIGS. 1-3, a tumble dryer 100 generally includes a drying chamber 102 (e.g., a rotatable drum located behind access door 104); a motor 302 used to, e.g., rotate the rotatable drum; an air supply channel 202 which introduces fresh air from within the dryer housing or cabinet 106 into the drying chamber 102 via rear manifold 210; a heater 208 provided at air supply channel 202, which heats the air introduced into the air supply channel 202; and an air exhaust channel 204 to exhaust hot air and water vapor from the dryer, typically to the outside of the house or other building in which the dryer is located.

A process air fan or blower 206 is provided downstream of the drying chamber 102 for drawing air through the system and out the exhaust channel 204. For example, process air fan 206 may draw air through an opening provided on a bottom of a bulkhead 216 of the drying chamber 102 and into front manifold 214. A lint filter 212 for collecting lint and other debris in the air is placed in the front manifold 214 between the drying chamber 102 and the exhaust channel 204. In such a tumble dryer 100, the sole heat source is the heater 208 upstream of the drying chamber 102. Further, heat recovery may take place by a slight warming of the air in cabinet 106 before it is drawn into heater 208, by virtue of the heat in the cabinet 106 generated by continued operation of the tumble dryer 100.

Some dryer systems use recirculated air in addition to the conventional heater 208 to improve energy efficiency. These systems mix a portion of the exhaust air with the air being introduced into the drying chamber. For example, commonly owned U.S. patent application Ser. No. 13/437,499, filed on Apr. 2, 2012, and entitled “Dryer With Air Recirculation Subassembly,” and Ser. No. 13/912,580, filed on Jun. 7, 2013, and entitled “Laundry Dryer with Accessible Recirculation Air Filter,” which are both hereby incorporated by reference in their entirety, each describe a dryer system using recirculated air to increase efficiency. In these systems, the warm, moisture-laden exhaust air holds the potential to absorb additional molecules of water when recirculated through the dryer, and thus the heat energy of that air can be reutilized to improve operating efficiency.

FIG. 4 illustrates the tumble dryer 100 employing a recirculation ventilation system, which redirects at least a portion of exhausted air back to air supply channel 202 and ultimately to drying chamber 102. Specifically, in the embodiment depicted in FIG. 4, the ventilation system of the tumble dryer 100 is similar to that depicted in FIGS. 1-3, except, in this embodiment, the ventilation system comprises air recirculation channel 402 connecting air exhaust channel 204 with air supply channel 202. In such an embodiment, when process air fan 206 pulls air from drying chamber 102 through the lint filter 212 and front manifold 214, a first portion of the air exiting the process air fan 206 is exhausted through exhaust channel 204, and a second portion of the air exiting the process air fan 206 is recirculated back to air supply channel 202 via air recirculation channel 402. This second portion is then combined with fresh air entering from cabinet 106 at inlet 404 and ultimately supplied back to drying chamber 102 through air supply channel 202. Accordingly, in this embodiment, air passing through air supply channel 202 (and across heater 208 within air supply channel 202) comprises air from cabinet 106 and recirculated air pulled from drying chamber 102. In the right proportions, use of such a combination may increase the overall efficiency of tumble dryer 100.

In still other dryer systems, the entire process air which passes through the drying chamber 102 may be cyclically circulated through the laundry dryer. For example, and as diagrammatically depicted in FIG. 5, rather than exhausting the entirety of the process air which passes through the drying chamber 102 (as shown and described in connection with FIG. 2), or exhausting a portion of the process air while recirculating a portion of the process air (as shown and described in connection with FIG. 4), some dryer systems may recirculate the entire process air which passes through the drying chamber 102 without exhausting any portion thereof. In such embodiments, the ventilation system of the dryer may fluidly connect the process air fan 206 to the air supply channel 202 such that all or nearly all of the process air exiting the drying chamber 102 is returned to the drying chamber. In such embodiments, a process air moisture condensing device 502, such as an air-to-air heat exchanger, or a heat exchanger of a refrigerant evaporator of a heat pump system, may be used to, e.g., remove moisture from the air before it is returned to the drying chamber 102.

For example, and as diagrammatically depicted in FIG. 5, in such closed process air circuit dryers, warm and damp process air which leaves the drying chamber 102 may first pass through the lint filter 212 and then through the process air moisture condensing device 502. The process air is cooled at the process air moisture condensing device 502 due to, e.g., heat transfer from the process air to refrigerant in a refrigerant evaporator of a heat pump system, or due to heat transfer to cool air drawn from the outside of the tumble dryer 100 in an air-to-air heat exchanger in a condenser-type tumble dryer 100. When the process air is cooled, moisture contained in the process air will condense and may be collected in a condensed moisture collector 504 (e.g., a condensate tank, a drain hose, etc.). The process air may then be circulated via the process air fan 206 to a heater (e.g., a resistance-type heater such as the canister heater 208 depicted in FIG. 2, a heat exchanger of a refrigerant condenser in a heat pump system, etc.) where it is subsequently heated and returned to the drying chamber 102 to further dry damp articles 506 contained therein.

In an effort to reduce as much as possible the chance of a fire or other burning within a dryer due to, e.g., the ignition of lint and/or debris, manufacturers adhere to one or more standards directed to fire suppression and/or concealment within laundry dryers. Such standards are becoming more and more restrictive and thus require appliance manufacturers to design laundry dryers so as to be able to pass the rigorous tests imposed by the standards in order to obtain the necessary safety certifications to sell their products as compliant with the corresponding standard. Thus, when designing and/or manufacturing a tumble dryer 100, manufacturers may include fire suppression and/or concealment systems in order to meet the rigors of one or more safety standards such that their appliance may ultimately be certified by the standard-setting body and thus sold in the corresponding market.

As an example of a mandatory standard in the U.S. market, Underwriters Laboratories (“UL”) maintains the UL 2158 standard, which, among other features, tests an electric dryer's ability to suppress and/or conceal an internal fire under both static (e.g., no air being moved through the dryer's ventilation system) and dynamic (e.g., air is being moved through the dryer's ventilation system) testing conditions. In order to meet the UL 2158 standard, a dryer must prevent an internal fire from spreading to a sheet draped over the appliance during testing under both conditions. If a dryer passes such a test (i.e., if the fire does not spread to the sheet draped over the dryer), the dryer may be marked and sold with the UL seal of approval.

Accordingly, some dryers include countermeasures to combat any internal fires which may ultimately result due to, e.g., heated lint and/or debris which has collected within a dryer during continued use of the dryer. For example, PCT Application Publication No. WO2013/037756, entitled “Laundry Dryer Having a Temperature-Activated Air-Flow Blocking Unit,” describes the use of an expandable material provided in a dryer which expands in elevated temperatures such that it either blocks an air inlet or releases a spring-loaded mechanism configured to block the air inlet. U.S. Pat. No. 6,725,570 and related U.S. Pat. No. 6,505,418, both entitled “Apparatus and Method for a Clothing Dryer Having a Fire Protection System,” describe a fire protection system which, in response to a dryer's internal controller determining a fire is present, injects a fire suppression substance into a drum of the dryer. Further, U.S. Pat. No. 6,655,047, entitled “Fire Arrester for Use with a Clothes Dryer,” describes a dryer which disconnects power to the dryer and releases an extinguishing agent or fire suppressant into the interior of the dryer in response to a fire detector sensing smoke. And U.S. Pat. No. 6,022,271, entitled “Fire Responsive Closing Air Vent,” describes a hingeable cover connected to an air vent held open by a meltable material which either shrinks or melts away in elevated temperatures thus causing the hinged cover to close the air vent when a fire is likely present.

Such systems may add considerable expense and complexity to an appliance, may be slow to detect and/or respond to a fire, and may be generally unreliable. Further, for systems controlled by a dryer's internal controller or which are supplied power by a dryer's main power circuit, such countermeasures may be prone to failure if, e.g., a fire damages or destroys the controller and/or main circuit before the countermeasures are utilized. Thus, there remains a need for a fire suppression or concealment system for a laundry dryer which is relatively inexpensive and reliable under a variety of fire conditions.

### BRIEF SUMMARY OF SELECTED INVENTIVE ASPECTS

The above and other drawbacks of existing dryer designs are addressed by the present invention. According to one aspect of the invention, a tumble dryer is provided with an air closure assembly configured to close at least one air passage of a ventilation system of the dryer when a sensor senses a condition indicative of a fire or burning within the tumble dryer. In some embodiments, the tumble dryer comprises an air closure assembly power circuit independent from one or more circuits used to supply power to one or more operative features of the laundry dryer apart from the air closure assembly. The air closure assembly power circuit is configured to supply power to the air closure assembly when the sensor senses a condition indicative of burning within the laundry dryer such that, when supplied with the power, the air closure assembly restricts the airflow through the ventilation system.

According to another aspect of the invention, an air closure system is provided which comprises a sensor, an air closure assembly, and an air closure assembly power circuit independent from one or more circuits used to supply power to one or more operative features of the laundry dryer apart from the air closure assembly. In some embodiments, the air closure assembly is configured to close off at least one air passage of the ventilation system of the tumble dryer when the sensor senses a condition indicative of a fire or burning within the tumble dryer. For example, the air closure assembly power circuit is configured to supply power to the air closure assembly when the sensor senses a condition indicative of burning within the laundry dryer such that, when supplied with the power, the air closure assembly restricts the airflow through the ventilation system.

According to yet another aspect of the invention, a method is provided for restricting airflow through a ventilation system of a tumble dryer when a sensor senses a condition indicative of a fire or burning within the tumble dryer. In response to sensing the condition indicative of burning within the tumble dryer, the method supplies power via a dedicated circuit to an actuator such that the actuator, in response to receiving the power via the dedicated circuit, releases a movable shutter which restricts airflow through the ventilation system of the laundry dryer.

### BRIEF DESCRIPTION OF THE DRAWINGS

The above and other features, aspects, and advantages of the invention will be fully apparent and understood from the following detailed description, taken together with the appended drawings, wherein:

FIG. 1 is a perspective view of a tumble dryer that may employ aspects of the invention.

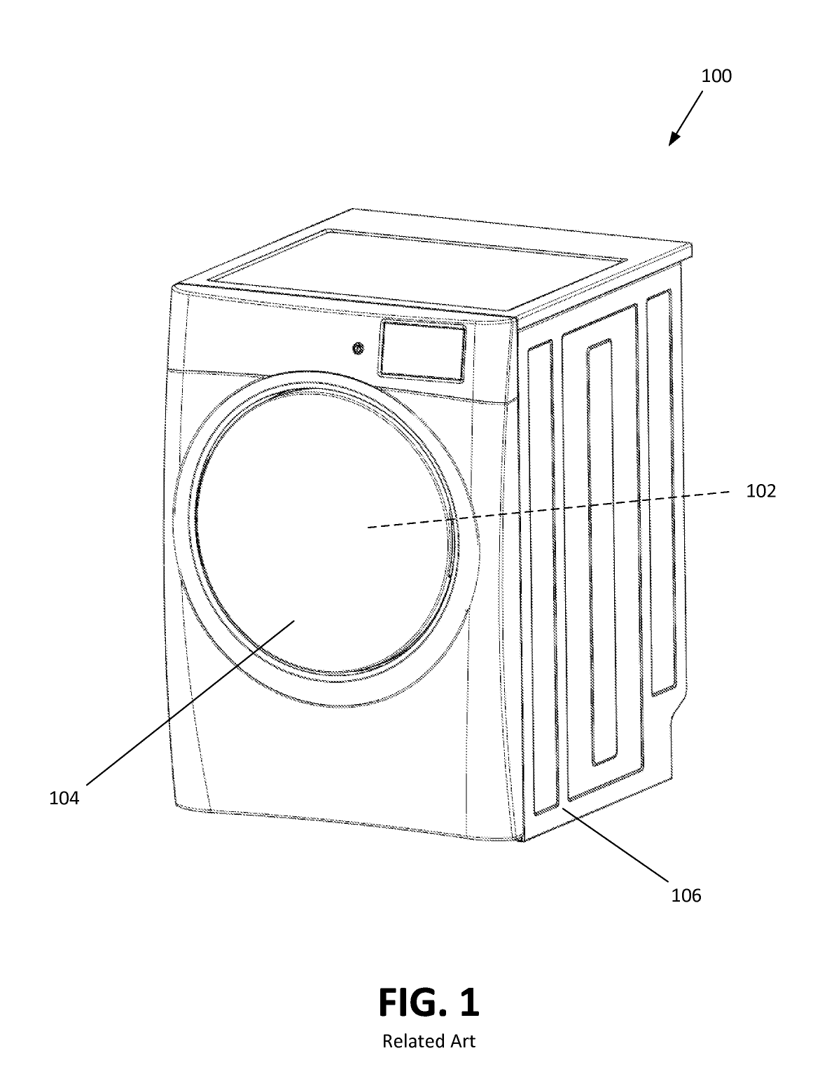

FIG. 2 is a perspective view showing internal components of a tumble dryer as shown in FIG. 1.

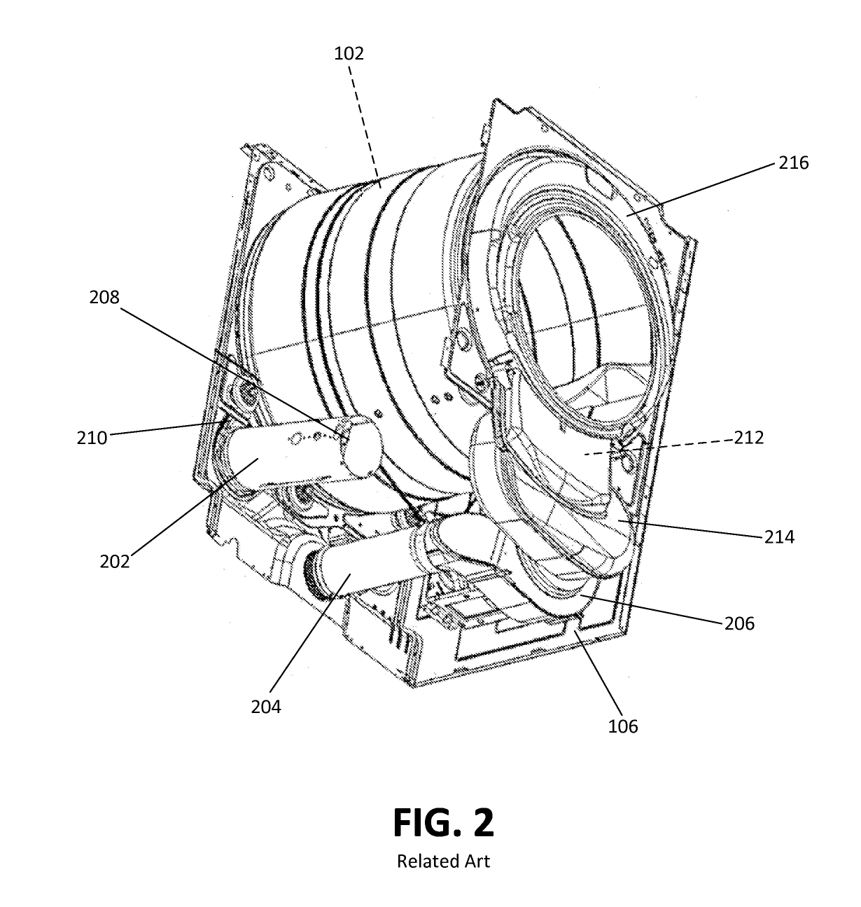

FIG. 3 is a perspective view of some of the internal components depicted in FIG. 2.

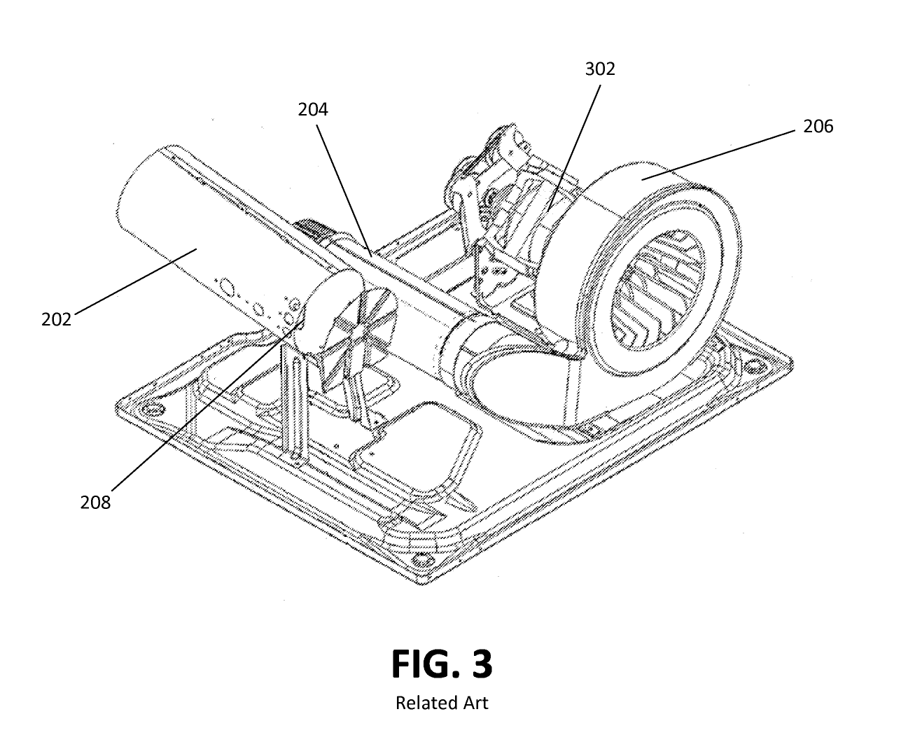

FIG. 4 is a perspective view showing internal components of a tumble dryer as shown in FIG. 1 employing a recirculation ventilation system.

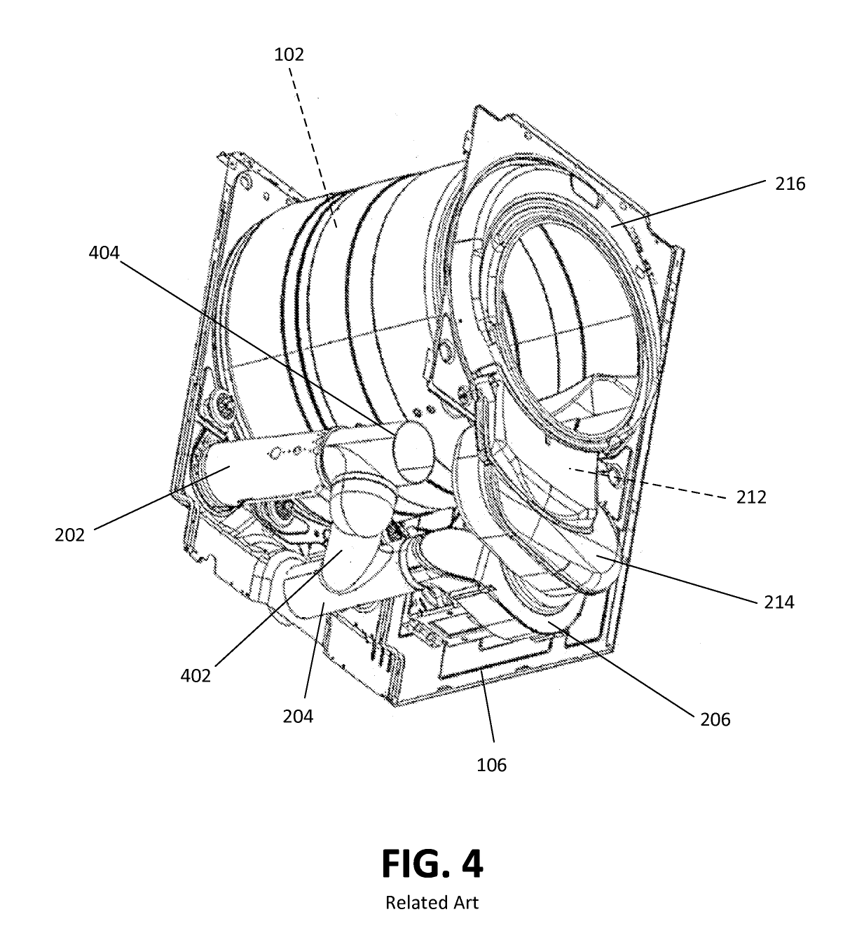

FIG. 5 is a process air flow diagram for a tumble dryer comprising a closed process air circuit which cyclically circulates process air through a drying chamber and which accordingly includes a process air moisture condensing device to remove moisture from the circulated process air.

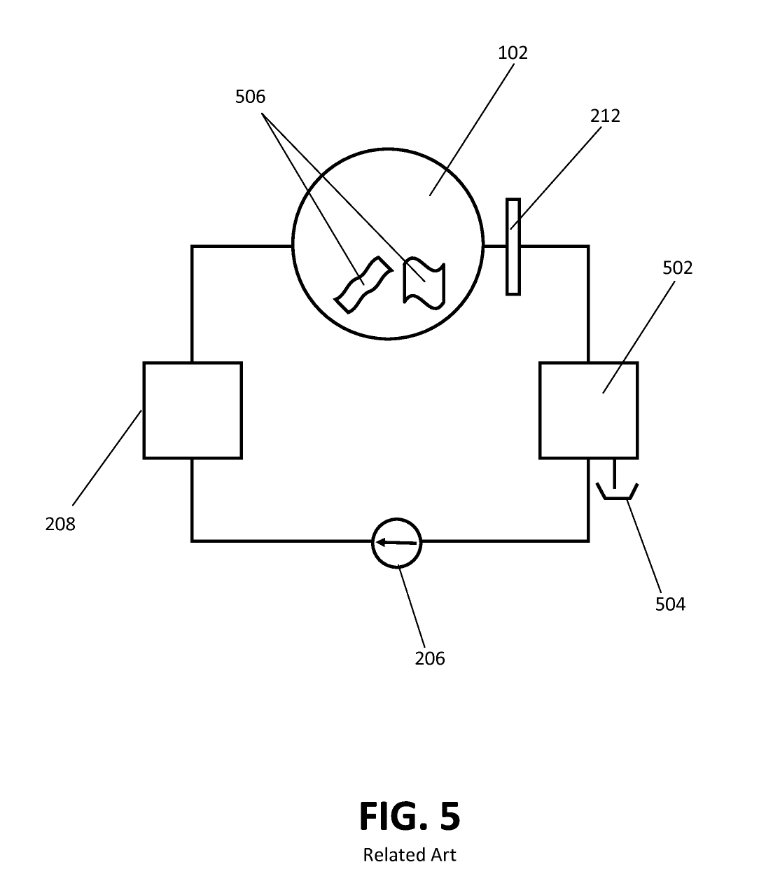

FIG. 6 is another perspective view of a tumble dryer generally as depicted in FIG. 1, but with a portion of the cabinet removed to show, in accordance with an aspect of the invention, a location of a sensor at a bulkhead of the drying chamber.

FIG. 7 is a perspective view of a portion of the bulkhead including the sensor depicted in FIG. 6.

FIG. 8 is a perspective view of a thermostat as one example of the sensor depicted in FIGS. 6-7 removed from the bulkhead of the drying chamber.

FIG. 9 is a schematic of an air closure assembly power circuit used to connect a power supply to an actuator via a sensor (e.g., the thermostat depicted in FIG. 8) according to aspects of the invention.

FIG. 10 is a perspective view of an air closure assembly used to suppress and/or conceal an internal fire of the tumble dryer depicted in FIG. 6 according to aspects of the invention.

FIGS. 11A and 11B are a side and top elevation view, respectively, of the air closure assembly depicted in FIG. 10.

FIG. 12 is a perspective view of a portion of the internal components of the tumble dryer depicted in FIG. 6 with the air closure assembly depicted in FIG. 10 coupled to the ventilation system according to aspects of the invention.

FIGS. 13A and 13B are elevation views of portions of the tumble dryer depicted in FIG. 6, with the air closure assembly coupled to the ventilation system as depicted in FIG. 12.

FIG. 14 is a partial horizontal sectional view taken on line 14-14 in FIG. 13A.

FIG. 15 is a perspective view of a portion of the internal components of the tumble dryer depicted in FIG. 6 with the air closure assembly depicted in FIG. 10 coupled to an air supply channel according to some aspects of the invention.

### DETAILED DESCRIPTION OF EXAMPLE EMBODIMENTS

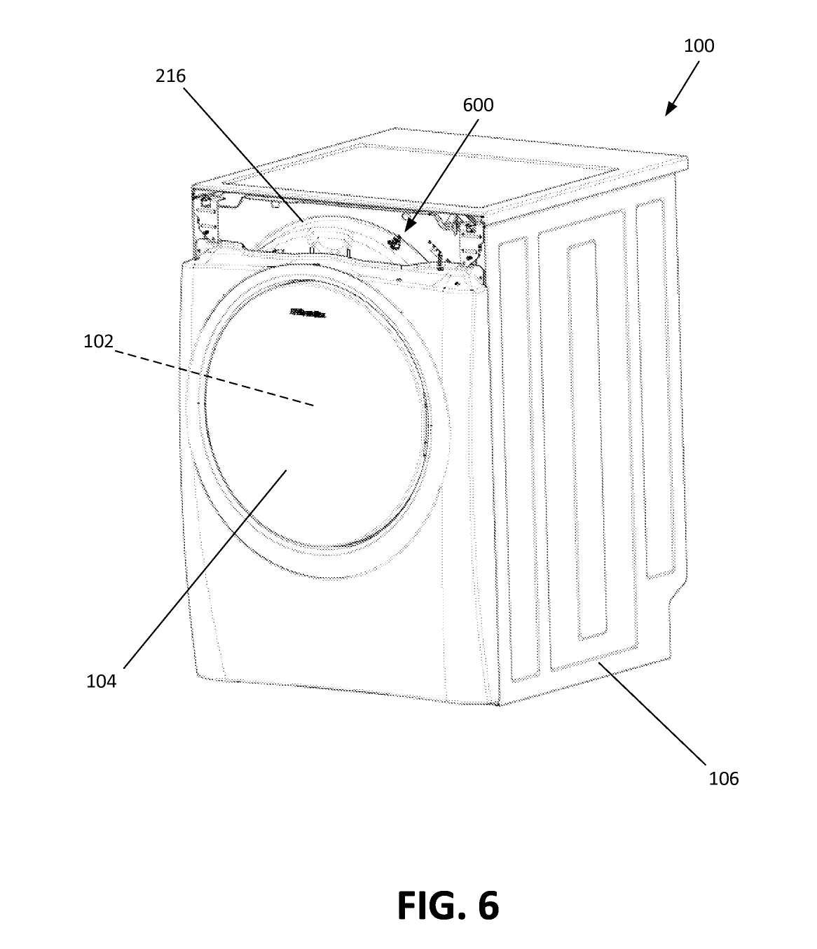

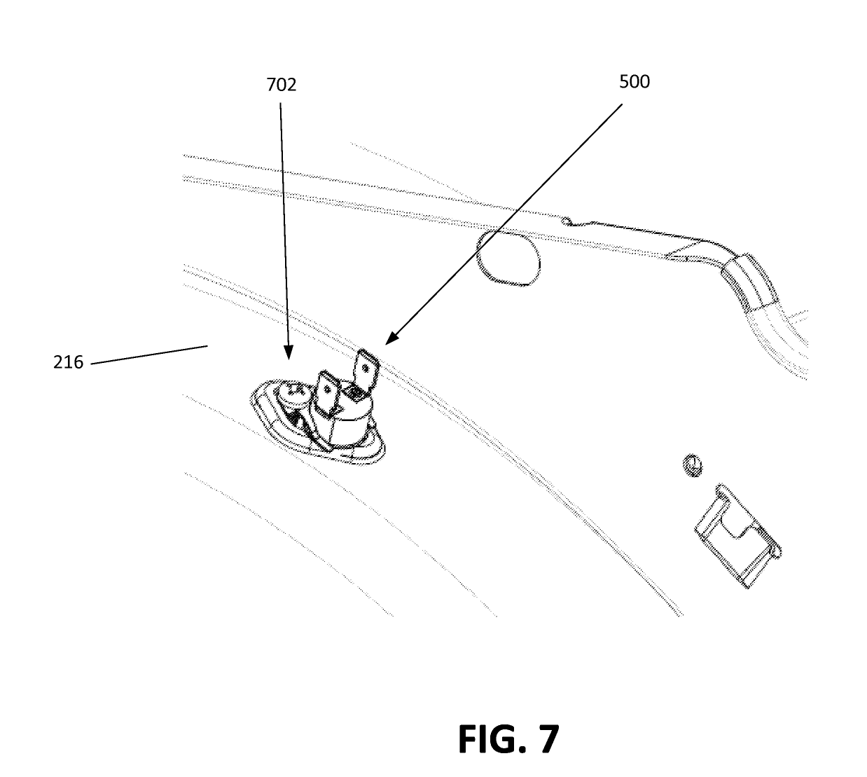

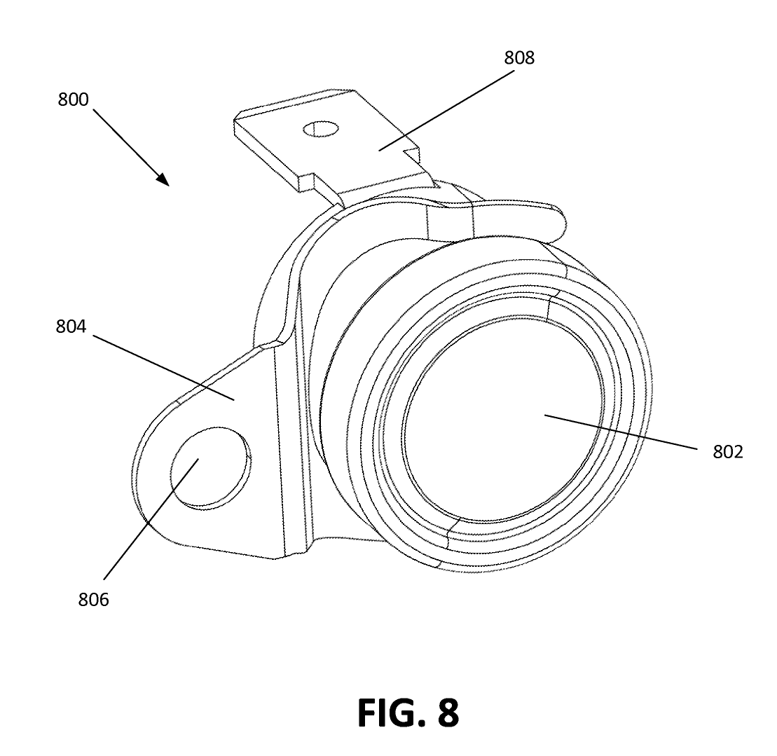

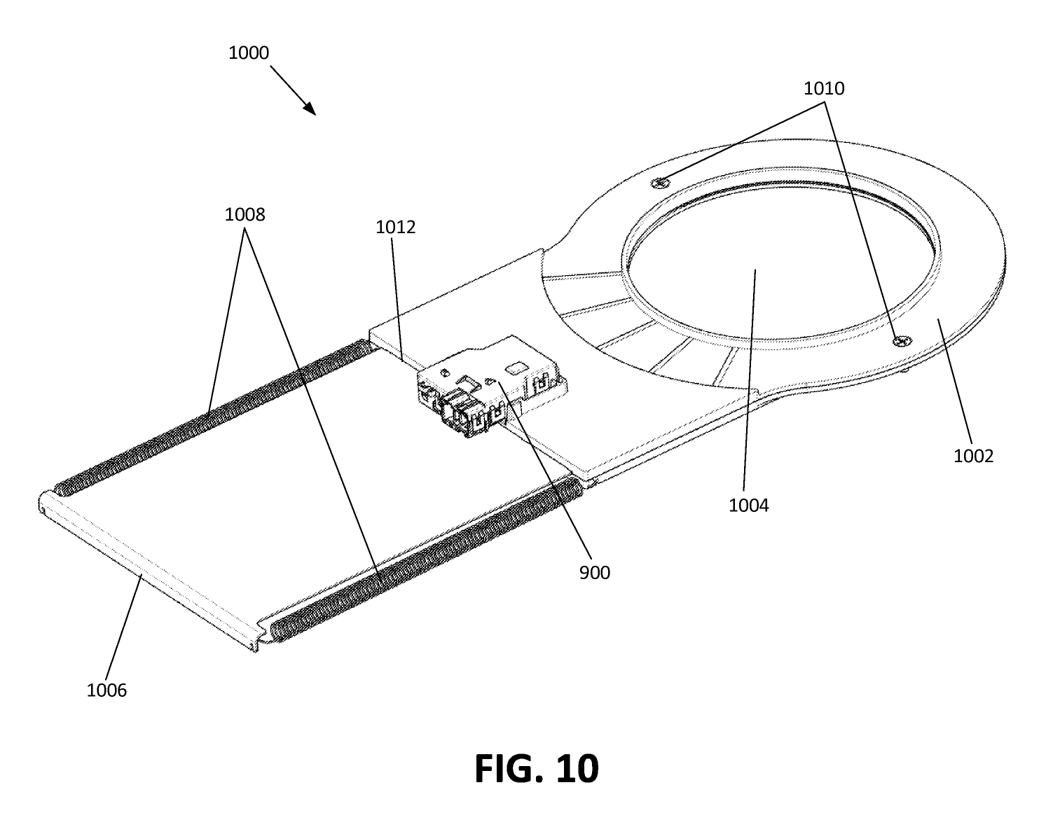

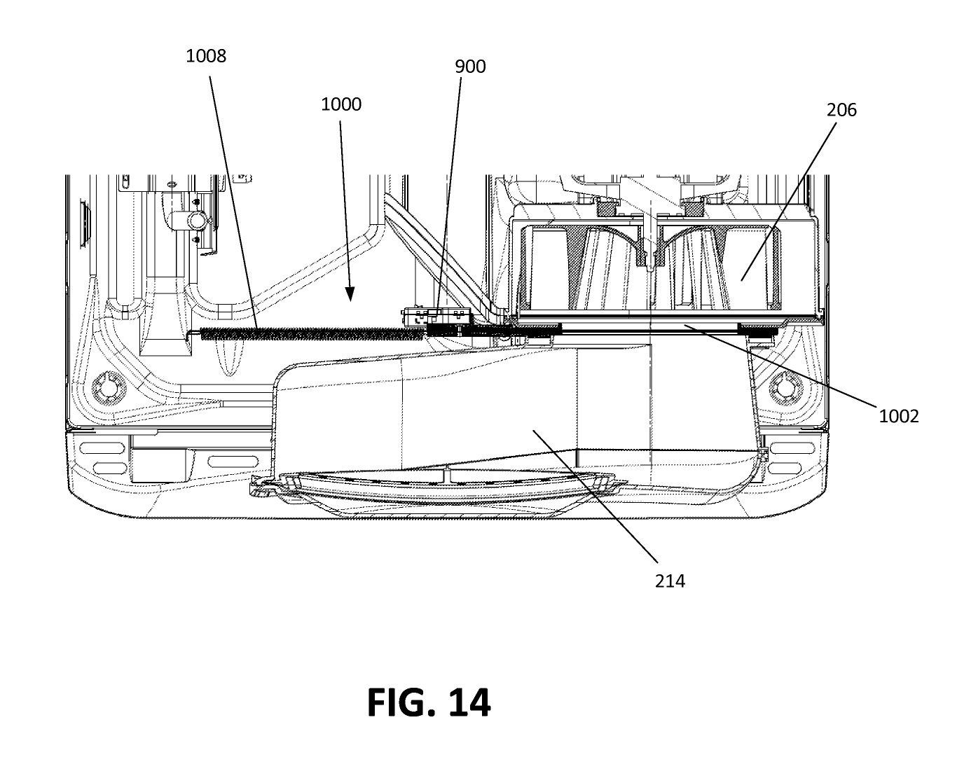

Referring to FIGS. 6-15, a tumble dryer 100 is equipped with an air closure system configured to suppress and/or conceal an internal fire within tumble dryer 100. As depicted in FIGS. 6-15, the tumble dryer 100 is a vented tumble dryer configured to exhaust at least a portion of air leaving a drying chamber 102 to an outside of the vented laundry dryer. In other suitable embodiments, the tumble dryer 100 may recirculate the entire process air which passes through the drying chamber 102 without exhausting any portion thereof. The air closure system may comprise a sensor 600 (e.g., a thermostat, smoke detector, or the like) disposed in a bulkhead 216 of the drying chamber 102 of the tumble dryer 100, and an air closure assembly 1000 (FIGS. 10-15) coupled to the ventilation system of the tumble dryer 100. In the embodiment depicted in FIG. 6, sensor 600 is disposed near the top of bulkhead 216, but, in other embodiments, sensor 600 may be disposed at other locations around the circumference of bulkhead 216 or within drying chamber 102. As more readily seen in FIGS. 7-8, sensor 600 may be secured to bulkhead 216 using any desirable fastener 702, and, in some embodiments, may be secured to bulkhead 216 using a threaded screw which extends through an opening 806 in a flange 804 of sensor 600.

Sensor 600 may be any desirable sensor used to sense a condition indicative of a fire or burning within tumble dryer 100. For example, in some embodiments, sensor 600 may comprise a smoke detector which senses the presence of smoke as indicative of a fire or burning within tumble dryer 100. In other embodiments, sensor 600 may comprise a thermostat 800 as depicted in FIG. 8 which senses an elevated temperature as indicative of a fire or burning within tumble dryer 100. As is known in the art, thermostat 800 may be an electrical switch configured to close a circuit once a temperature sensor 802 of thermostat 800 senses a temperature at or above a predetermined threshold temperature. For example, thermostat 800 may comprise two prongs 808 which may connect to a break in an electrical lead of a circuit (to be discussed more fully). In a default state, the thermostat 800 may be “open,” i.e., the thermostat 800 will continue to act as a break in a circuit and thus no electrical current will flow through the electrical lead. However, in a second state, the thermostat 800 may be “closed,” i.e., the thermostat 800 may complete the circuit and thus allow electricity to flow through the electrical lead. In such embodiments, thermostat 800 may be configured to be in the first, open state when temperature sensor 802 senses a temperature below the predetermined threshold temperature, and in the second, closed state when temperature sensor 802 senses a temperature above the predetermined threshold temperature.

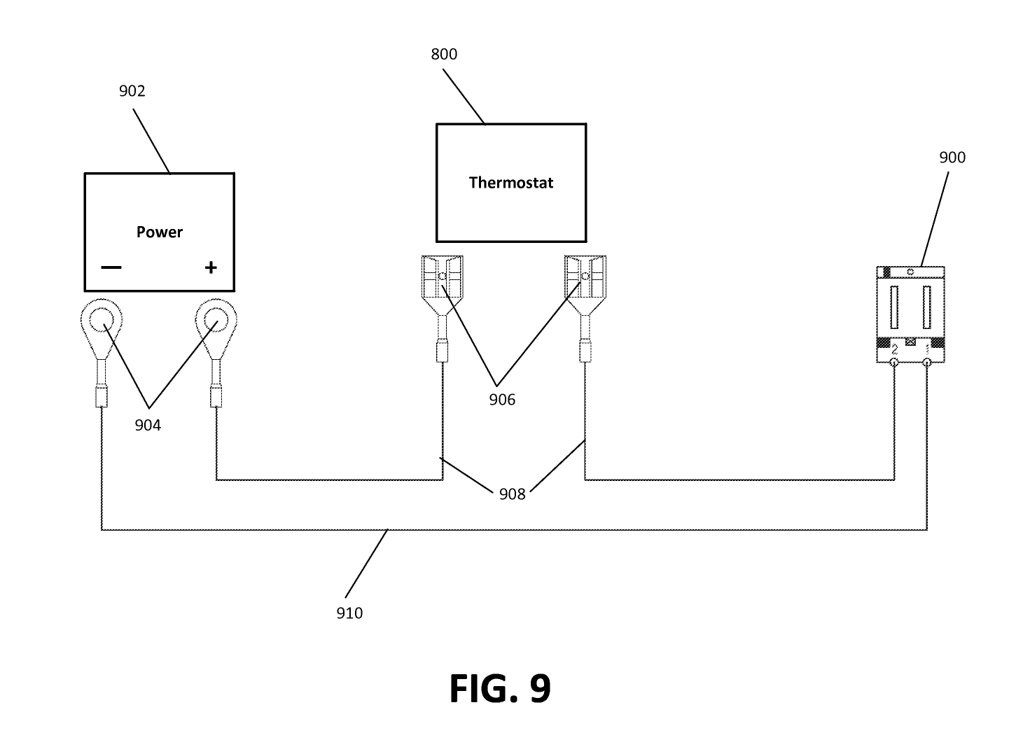

This may be more readily understood with reference to FIG. 9. FIG. 9 is a schematic of an air closure assembly power circuit used in connection with embodiments of the invention. As shown in FIG. 9, a power supply 902 may be connected via connectors 904, positive lead 908, and negative lead 910, to an actuator 900 (to be discussed more fully). Further, thermostat 800 (or any other suitable sensor 600) may be connected to a break in one of the leads (in the depicted embodiment, positive lead 908) via connectors 906 attached to prongs 808. In such an arrangement, when thermostat 800 is in the first, open state (e.g., when thermostat 800 has not sensed a temperature above a predetermined threshold temperature) thermostat 800 will thus represent a break in the circuit, and actuator 900 will receive no electricity from power supply 902. However, when thermostat 800 is in the second, closed state (e.g., when thermostat 800 has sensed a temperature above a predetermined threshold temperature) thermostat 800 will complete the circuit (e.g., “close” the break in positive lead 908) and thus electricity will be supplied to actuator 900.

Thus, in the depicted embodiment, power may selectively be supplied to actuator 900 according to a sensed temperature by thermostat 800. For example, for a thermostat 800 disposed at bulkhead 216 and utilized in the air closure assembly power circuit of FIG. 9, when the temperature at bulkhead 216 reaches the predetermined threshold temperature, the thermostat 800 will “close” and complete the circuit, thus supplying electricity to actuator 900. Once actuator 900 receives such an electrical current, it may in turn actuate an air closure assembly 1000 (to be more fully discussed). In such embodiments, if the predetermined threshold temperature is configured to be a temperature indicative of a fire or burning within cabinet 106 (e.g., a fire within drying chamber 102, the ventilation system, and/or a basement of cabinet 106), the actuator 900 will thus actuate air closure assembly 1000 when, e.g., thermostat 800 senses a temperature indicative of a fire or burning within tumble dryer 100.

Those skilled in the art, given the benefit of this disclosure, will appreciate that any suitable sensor 600 may be provided at the break in positive lead 908 and yield similar benefits as those provided by thermostat 800 described above. For example, a smoke detector (as one example of sensor 600) may be provided at the break in positive lead 908 which is configured to, e.g., complete the depicted circuit when the smoke detector senses smoke within tumble dryer 100. Any other desirable sensor 600 and/or control configured to open and close a circuit (e.g., the air closure assembly power circuit depicted in FIG. 9) in response to the sensor 600 sensing a condition indicative of a fire or burning within tumble dryer 100 may be used without departing from the scope of this disclosure. This includes a sensor that outputs an analog or digital signal as a function of a sensed temperature, together with a controller that switches the circuit open or closed based upon a comparison of the output signal with a value representing a threshold temperature. In such embodiments, the sensor may be powered by power supply 902.

In some embodiments, the air closure assembly power circuit depicted in FIG. 9 may be independent from, e.g., one or more other circuits used to control the operative features of tumble dryer 100 apart from the actuator 900. For example, a main circuit (not shown) may be used to supply power to, e.g., a motor 302, process air fan 206, heater 208, etc., of tumble dryer 100. Further, the air closure assembly power circuit depicted in FIG. 9 used to supply power to actuator 900 may be independent of this main circuit. In such embodiments, if the main circuit is damaged or should fail (e.g., if a controller (not shown) provided in main circuit malfunctions or fails due to the fire or burning within tumble dryer 100), the circuit supplying power to the actuator 900 will nonetheless be unaffected. Thus, in such embodiments, the actuator 900 will receive power if a threshold condition is met (e.g., thermostat 800 switching closed upon sensing a temperature above a predetermined temperature, a smoke detector sensing smoke, etc.) regardless of whether or not the main circuit and/or a controller of the main circuit are damaged, malfunctioning, or have failed.

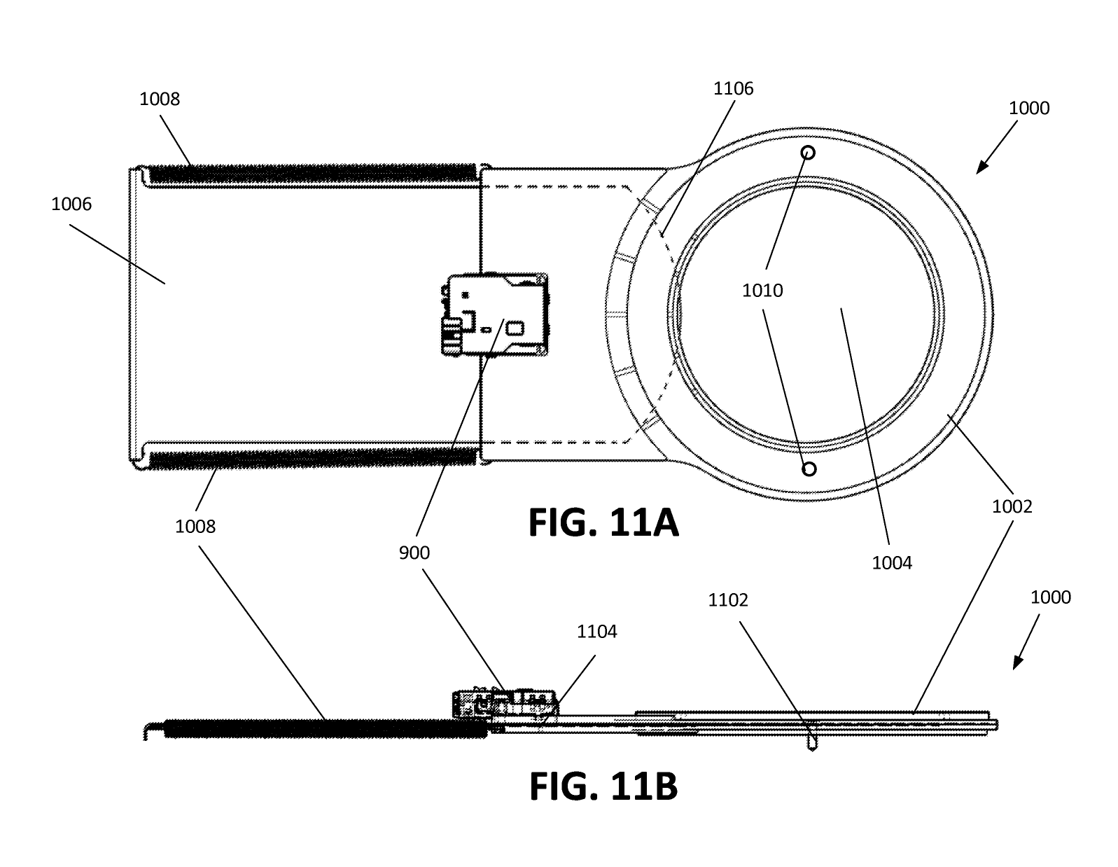

Turning now to FIGS. 10-11B, actuator 900 may be coupled to (and configured to actuate as will be more fully discussed) air closure assembly 1000. Air closure assembly 1000 may be configured to restrict air movement through one or more air passages of the ventilation system of tumble dryer 100 when actuated by actuator 900 (e.g., when sensor 600 senses a condition indicative of a fire or burning within tumble dryer 100 as discussed). Air closure assembly 1000 may comprise a guide 1002 including an opening 1004, a shutter 1006 movably coupled to the guide 1002 (in the depicted embodiment, slidably received in a corresponding track 1012 of guide 1002), one or more urging members 91008 (in the depicted embodiments, springs) connected to the shutter 1006, and one or more mounting holes 1010 provided in the guide 1002 for mounting air closure assembly 1000 to the ventilation system. Guide 1002 may be made of any suitable material, and, in some embodiments, may be made of a thermoplastic material such as, e.g., polyvinyl chloride (PVC). Further, shutter 1006 may be made of any suitable material, and may be fire resistant or fireproof. For example, in some embodiments shutter 1006 may be made of, e.g., metal, such as stainless steel.

Actuator 900 may be coupled to the guide 1002, and may be configured to hold the shutter 1006 in place with respect to the guide 1002. Actuator 900 may be any actuator known in the art, and, in some embodiments, actuator 900 may comprise a linear solenoid. In such embodiments, the linear solenoid of actuator 900 may comprise a sliding member 1104 configured to, e.g., extend or retract from the actuator 900 in response to the actuator 900 and/or linear solenoid being supplied an electrical current. In some embodiments, the sliding member 1104 may extend into, e.g., a hole, depression, and the like, provided in shutter 1006 and may generally hold shutter 1006 in place with respect to the guide 1002 when so extended. In such embodiments, no electrical current is necessary in order to keep the sliding member 104 extended into the hole, depression, or the like. For example, an elastic member or the like (not shown) may urge the sliding member 104 into the hole when no electrical current is supplied to the actuator 900. Further, because one or more urging members 91008 are connected to shutter 1006 and because shutter 1006 is movably coupled to the guide 1002, when the actuator 900 does not hold shutter 1006 in place with respect to guide 1002 (e.g., when the sliding member 1104 is removed from the hole, depression, and the like, provided in shutter 1006), the shutter 1006 may slide along and further into the corresponding receiving track 1012 provided in guide 1002 due to an urging force applied to shutter 1006 by the one or more urging members 91008. Thus, for the embodiments depicted in FIGS. 10-11B, when the sliding member 1104 is removed from the shutter 1006 (e.g., when actuator 900 receives an electrical current from power supply 902) the shutter 1006 may slide in the track 1012 of guide 1002 in a generally left to right direction as seen in the drawing.

As seen in FIG. 11A, shutter 1006 may comprise a convexly curved leading edge 1106. In such embodiments, when shutter 1006 is in a first state (i.e., when sliding member 1104 engages shutter 1006 such that shutter does not move with respect to guide 1002) leading edge 1106 does not restrict or only negligibly restricts opening 1004. Thus, in such a position, shutter 1006 will not disrupt airflow through opening 1004 when air closure assembly 1000 is mounted, using known type fastener 1102, to the ventilation system of tumble dryer 100 (to be discussed more fully). However, and because a width of shutter 1006 (i.e., length of shutter 1006 in the top to bottom direction as depicted in FIG. 11A) is at least as wide as opening 1004, and because the leading edge 1106 of shutter 1006 is convex and generally follows the contour of the edge of opening 1004, when the shutter 1006 is in a second state (i.e., when the shutter 1006 slides to the right in the track 1012 of guide 1002 of the air closure assembly 1000) shutter 1006 will seal off opening 1004. Thus, in such a position, shutter 1006 will completely restrict or nearly completely restrict airflow though opening 1004 when air closure assembly 1000 is mounted to the ventilation system of tumble dryer 100 (to be discussed more fully).

Returning FIG. 9, when the actuator 900 is thus provided as part of a circuit connected to a power supply via thermostat 800 (or any other desired sensor 600), actuator 900 will not receive an electrical current and thus will keep shutter 1006 in the first state such that airflow within the ventilation system is not restricted when, e.g., the thermostat 800 senses a temperature at bulkhead 216 below a predetermined threshold temperature. However, actuator 900 will receive an electrical current and thus release shutter 1006 closing off the airflow through the ventilation system when the thermostat 800 senses a temperature at bulkhead 216 above the predetermined threshold temperature. Accordingly, when the thermostat 800 is configured such that the predetermined threshold temperature is one indicative of a fire or burning within tumble dryer 100, the system described herein can advantageously close off the ventilation system of a tumble dryer 100 when such temperature (and thus a fire or burning) is sensed within cabinet 106 (e.g., at bulkhead 216). By closing off the ventilation system, the fire or burning may be both suppressed (because, e.g., a draw of oxygen is reduced or shut off to the fire) and concealed (because, e.g., shutter 1006 may serve as a firewall particularly when shutter 1006 is constructed of fire-resistant or fireproof materials).

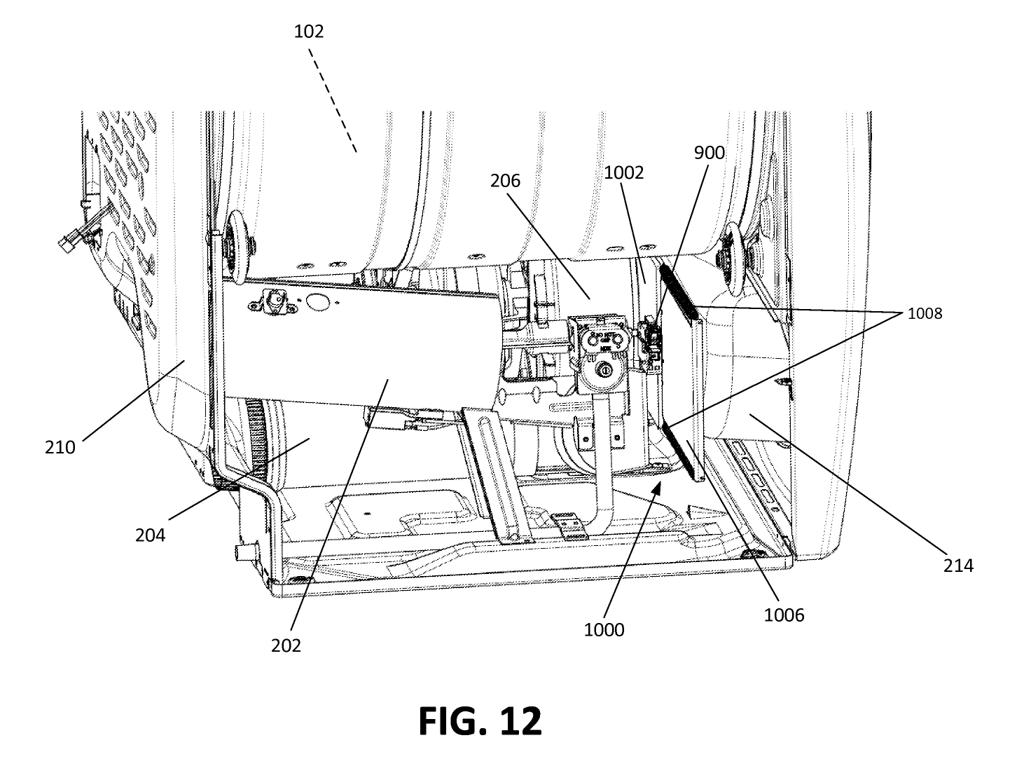

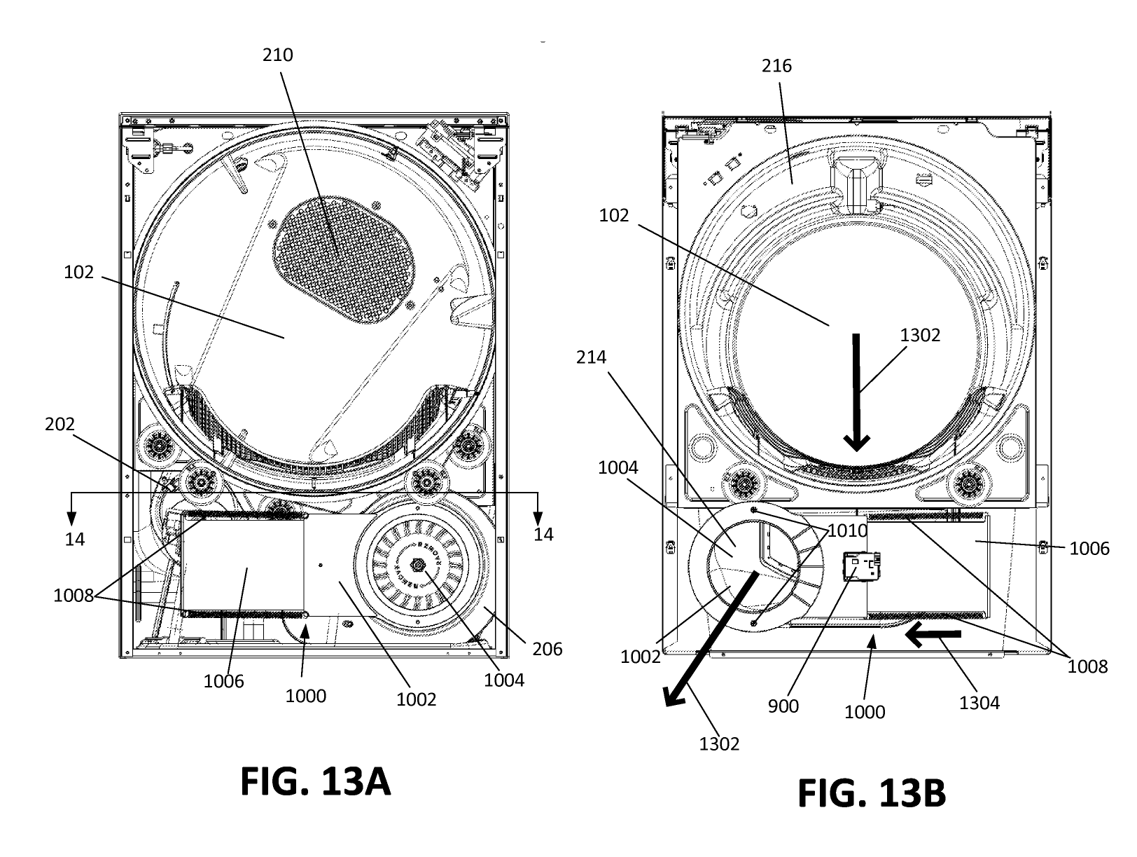

This will more readily apparent with reference to FIGS. 12-15. FIGS. 12-15 illustrate embodiments where the air closure assembly 1000 as described is coupled to the ventilation system of tumble dryer 100. First, in the embodiment depicted in FIGS. 12-14, air closure assembly 1000 is coupled to the ventilation system between an outlet of front manifold 214 and an inlet of process air fan 206. Specifically, the guide 1002 of air closure assembly 1000 is mounted to the front manifold 214 and/or the process air fan 206 via one or more fasteners 1102 provided through one or more mounting holes 1010 such that opening 1004 is in line with an air passage between the front manifold 214 and the air process fan 206 as more readily seen in FIGS. 13A-13B. Thus, when the shutter 1006 of air closure assembly 1000 is in the first, open state as described (i.e., when the sensor 600 has not sensed a condition indicative of a fire or burning), airflow through the ventilation system (specifically, through an air passage between the front manifold 214 and the process air fan 206) is not restricted. However, when the shutter 1006 of air closure assembly 1000 is in the second, closed state as described (i.e., when the sensor 600 has sensed a condition indicative of a fire or burning), airflow through the ventilation system (specifically, through an air passage between the front manifold 214 and the process air fan 206) is restricted.

To better illustrate such features, airflow arrows 1302 are provided to indicate a typical airflow path through the portion of the ventilation system illustrated in FIG. 13B (e.g., front manifold 214). As shown, air leaving drying chamber 102 is drawn through an opening in the bulkhead 216 and through front manifold 214 by, e.g., the operation of process air fan 206. This air passes through opening 1004 of guide 1002 of air closure assembly 1000 (mounted at an outlet of front manifold 214) when shutter 1006 is in the first, open state. However, as illustrated by shutter movement arrow 1304 and described above, shutter 1006 is configured to slidably move to a second, closed state, where it will restrict and/or completely block airflow through the ventilation system at the air passage from front manifold 214 to process air fan 206. In such a state, shutter 1006 may serve to suppress and/or conceal a fire within cabinet 106 (e.g., a fire within a basement portion of cabinet 106, within the ventilation system, and/or within drying chamber 102). For example, in such a closed state, shutter 1006 may serve to shut down the flow of oxygen to a fire, as the airflow through the ventilation system will be either completely or nearly completely blocked. Further, shutter 1006 may serve to conceal the fire to a compartment of tumble dryer 100 where the fire first began (e.g., drying chamber 102, front manifold 214, etc.) as shutter 1006 will act as a firewall (i.e., a barrier to the fire spreading to other flammable materials within the cabinet 106 of tumble dryer 100). For example, a fire that starts within front manifold 214 will not receive a draw of oxygen from process air fan 206, as the air passage between front manifold 214 and process air fan 206 will be closed by shutter 1006. Further, a fire starting within front manifold 214 will not spread to, e.g., lint or debris within process air fan 206, a basement of cabinet 106, etc., as shutter 1006 will serve as a firewall between front manifold 214 and process air fan 206 or other components.

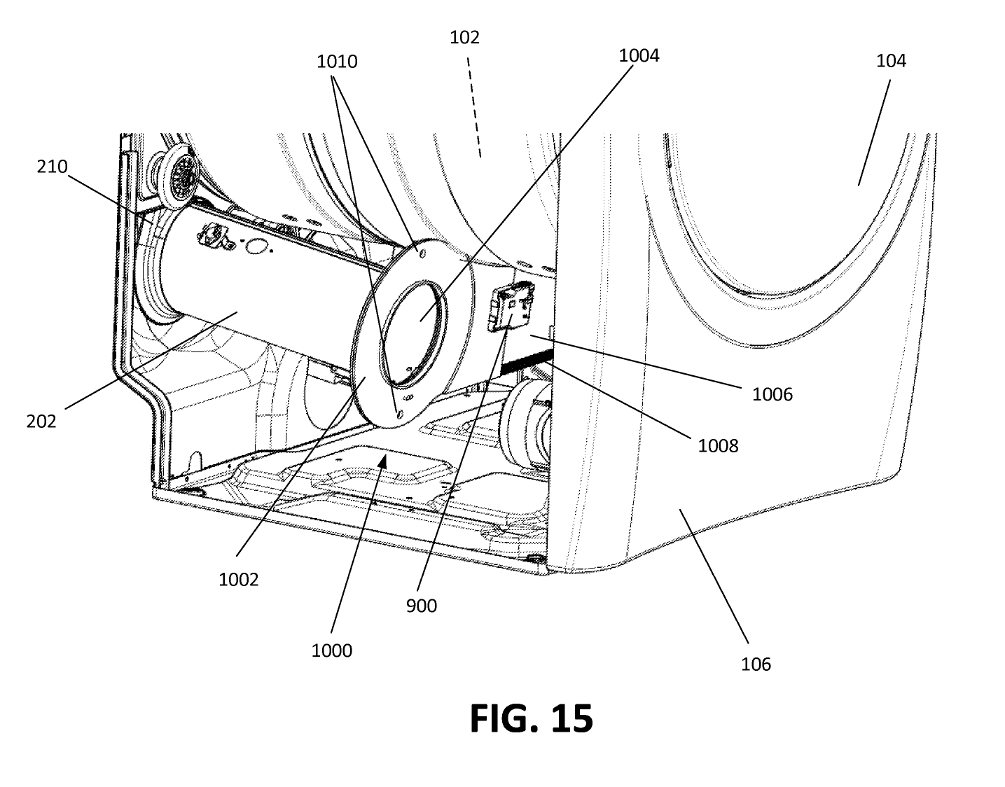

One skilled in the art, given the benefit of this disclosure, will appreciate that, in other embodiments, air closure assembly 1000 may be mounted at other locations along the ventilation system of tumble dryer 100 and provide the benefits as discussed with respect to FIGS. 12-14. For example, FIG. 15 illustrates an embodiment where air closure assembly 1000 is mounted at an air intake of air supply channel (heater canister) 202. In such embodiments, air closure assembly 1000 may operate in a substantially similar manner as described above. For example, a shutter 1006 of air closure assembly 1000 may be configured to be in a first, open state when sensor 600 does not sense a condition indicative of a fire or burning within tumble dryer 100. In such embodiments, air closure assembly 1000 will not restrict or only negligibly restrict air entering the ventilation system at air supply passage 202 when sensor 600 does not sense such a condition. However, in a second, closed state (which shutter 1006 may slidably move to when sensor 600 senses a condition indicative of a fire or burning within the tumble dryer 100), shutter 1006 may completely or nearly completely block off airflow through opening 1004. In such a state, shutter 1006 will prevent air from entering air supply channel 202 (an inlet of which opening 1004 is aligned) and thus will shut off a fresh supply of air to the fire while concealing an opening between the ventilation system (i.e., the inlet of air supply channel 202) and the basement of the cabinet 106. Thus, air closure assembly 1000 may be provided in a variety of locations along the ventilation system of tumble dryer 100 and provide beneficial suppression and/or concealment benefits accordingly.

The air closure system as described herein may provide many advantages over existing fire countermeasures currently employed. For example, as compared to complex extinguisher systems and the like, the system described herein may be relatively inexpensive. Further, the system may be capable of installation at a variety of locations along a ventilation system as discussed, and thus may be employed in a variety of dryer configurations in both conventional and recirculation dryers. Additionally, the system may comprise a dedicated circuit independent of, e.g., one or more circuits used to supply power to other operative features of the dryer apart from the air closure assembly. Accordingly, the system may not be dependent on a main circuit and/or an internal controller of a dryer, and thus may be capable of suppressing and/or concealing a fire even if the main circuit and/or internal controller is destroyed by the fire or otherwise malfunctions. And, unlike many countermeasures currently employed, the system may serve to both suppress a fire (by restricting airflow) and conceal a fire (by serving as a firewall), thus providing increased protection from the fire spreading outside of the dryer cabinet.

The present invention has been described in terms of preferred and exemplary embodiments thereof. Numerous other embodiments, modifications, and variations within the scope and spirit of the appended claims will occur to persons of ordinary skill in the art from the review of this disclosure. For example, embodiments of the invention may be carried out in a laundry dryer having a ventilation system provided for circulating cyclically the drying air through the drying chamber without exhausting such air outside the dryer. In such embodiments, the dryer may be provided with a device configured to remove moisture from the process air once the process air leaves the drying chamber.

We claim:

1. A laundry dryer comprising:
a cabinet;
a drying chamber provided within the cabinet;
a ventilation system comprising an air supply channel configured to supply air to the drying chamber, and a process air fan configured to move the air through the drying chamber;
a sensor;
an air closure assembly configured to restrict airflow through the ventilation system; and
an air closure assembly power circuit configured to supply power to the air closure assembly, wherein:
the air closure assembly power circuit is independent from one or more circuits used to supply power to one or more operative features of the laundry dryer apart from the air closure assembly;
the air closure assembly power circuit is configured to supply power to the air closure assembly when the sensor senses a condition indicative of burning within the laundry dryer; and
when supplied with power, the air closure assembly restricts airflow through a ventilation system of the laundry dryer.

2. The laundry dryer of claim 1, wherein the sensor is configured to complete the air closure assembly power circuit such that the air closure assembly power circuit supplies an electrical current to the air closure assembly when the sensor senses the condition indicative of burning within the laundry dryer.

3. The laundry dryer of claim 2 wherein the air closure assembly comprises:
a guide coupled to the ventilation system; and
a shutter movably coupled to the guide, wherein, when the sensor does not sense the condition indicative of burning within the laundry dryer, the shutter is configured to remain in a first state where the shutter does not restrict the airflow through the ventilation system, and wherein, when the sensor senses the condition indicative of burning within the laundry dryer, the shutter is configured to move to a second state where the shutter restricts the airflow through the ventilation system.

4. The laundry dryer of claim 3, wherein the sensor is a thermostat, wherein the condition indicative of burning within the laundry dryer is a sensed predetermined temperature, wherein, when the thermostat senses a temperature below the predetermined temperature, the shutter is configured to remain in the first state, and wherein, when the thermostat senses a temperature above the predetermined temperature, the shutter is configured to move to the second state.

5. The laundry dryer of claim 3, wherein the air closure assembly further comprises one or more urging members connected to the shutter, wherein the shutter is configured to move to the second state due to an urging force applied to the shutter by the one or more urging members.

6. The laundry dryer of claim 5, wherein the air closure assembly further comprises an actuator, wherein the actuator prevents the shutter from moving from the first state when the sensor does not sense the condition indicative of burning within the laundry dryer, and wherein the actuator releases the shutter such that it moves to the second state via the urging force when the sensor senses the condition indicative of burning within the laundry dryer.

7. The laundry dryer of claim 6, wherein the actuator comprises a linear solenoid including a sliding member, wherein the sliding member extends into the shutter when the shutter is in the first state, and wherein the sliding member is removed from the shutter when the air closure assembly is supplied with the electrical current.

8. The laundry dryer of claim 3, wherein the guide is disposed at an inlet side of the process air fan.

9. The laundry dryer of claim 1, wherein the sensor is disposed at a bulkhead of the drying chamber.

10. The laundry dryer of claim 1, wherein the laundry dryer is a vented laundry dryer configured to exhaust at least a portion of air leaving the drying chamber to an outside of the vented laundry dryer.

11. The laundry dryer of claim 1, wherein the laundry dryer comprises a closed process air circuit configured to cyclically circulate the air through the drying chamber.

12. An air closure system configured to restrict airflow in a ventilation system of a laundry dryer, the air closure system comprising:
a sensor;
an air closure assembly; and
an air closure assembly power circuit configured to supply power to the air closure assembly, wherein:
the air closure assembly power circuit is independent from one or more circuits used to supply power to one or more operative features of a laundry dryer apart from the air closure assembly;
the air closure assembly power circuit is configured to supply power to the air closure assembly when the sensor senses a condition indicative of burning within the laundry dryer; and
when supplied with power, the air closure assembly restricts airflow through a ventilation system of the laundry dryer.

13. The air closure system of claim 12, wherein the sensor is configured to complete the air closure assembly power circuit such that the air closure assembly power circuit supplies an electrical current to the air closure assembly when the sensor senses the condition indicative of burning within the laundry dryer.

14. The air closure system of claim 13, wherein the air closure assembly further comprises:
a guide configured to couple to the ventilation system of the laundry dryer; and
a shutter movably coupled to the guide, wherein, when the sensor does not sense the condition indicative of burning within the laundry dryer, the shutter is configured to remain in a first state where the shutter does not restrict the airflow through the ventilation system, and wherein, when the sensor senses the condition indicative of burning within the laundry dryer, the shutter is configured to move to a second state where the shutter restricts the airflow through the ventilation system.

15. The air closure system of claim 14, wherein the sensor is a thermostat, wherein the condition indicative of burning within the laundry dryer is a sensed predetermined temperature, wherein, when the thermostat senses a temperature below the predetermined temperature, the shutter is configured to remain in the first state, and wherein, when the thermostat senses a temperature above the predetermined temperature, the shutter is configured to move to the second state.

16. The air closure system of claim 14 further comprising one or more urging members connected to the shutter, wherein the shutter is configured to move to the second state due to an urging force applied to the shutter by the one or more urging members.

17. The air closure system of claim 16 further comprising an actuator, wherein the actuator prevents the shutter from moving from the first state when the sensor does not sense the condition indicative of burning within the laundry dryer, and wherein the actuator releases the shutter such that it moves to the second state via the urging force when the sensor senses the condition indicative of burning within the laundry dryer.

18. The air closure assembly of claim 17, wherein the actuator comprises a linear solenoid including a sliding member, wherein the sliding member extends into the shutter when the shutter is in the first state, and wherein the sliding member is removed from the shutter when the actuator is supplied with the electrical current.

19. The air closure assembly of claim 14, wherein the guide is configured to attach at an inlet side of a process air fan of the laundry dryer.

20. The air closure assembly of claim 12, wherein the sensor is configured to attach to a bulkhead of the drying chamber.

21. A method for restricting airflow through a ventilation system of a laundry dryer, the method comprising:
sensing a condition indicative of burning within a laundry dryer; and
in response to the sensing the condition indicative of burning within the laundry dryer, supplying power via a dedicated circuit to an actuator, wherein:
the dedicated circuit is independent from one or more circuits used to supply power to one or more operative features of the laundry dryer apart from the actuator;
the actuator, in response to receiving the power via the dedicated circuit, releases a movable shutter; and
the movable shutter, once released, restricts airflow through a ventilation system of the laundry dryer.

22. The method of claim 21, wherein the sensing the condition indicative of burning within the laundry dryer comprises sensing, with a thermostat, a temperature at a bulkhead of a drying chamber of the laundry dryer.
